(19) United States
(12) Patent Application Publication
(10) Pub. No.: US 2026/0284949 A1
(43) Pub. Date: Sep. 24, 2026

(54) METHOD FOR MANUFACTURING POROUS FILM, AND POROUS FILM MANUFACTURED THEREBY

(71) Applicant: Sunghee AHN, Seoul (KR)

(72) Inventor: Sunghee AHN, Seoul (KR)

(21) Appl. No.: 19/473,914

(22) PCT Filed: Apr. 15, 2024
(86) PCT No.: PCT/KR2024/095708

§ 371 Date: Oct. 9, 2025

(30) Foreign Application Priority Data
Apr. 13, 2023 (KR) 10-2023-0048599
Apr. 12, 2024 (KR) 10-2024-0049343

(51) Int. Cl. B29C 48/00; B29C 48/08

(52) U.S. Cl. CPC B29C 48/0018; B29C 48/08; B29C 2791/003; B29K 2995/0041

(57) ABSTRACT

The present invention relates to a method for manufacturing a porous film and to a porous film produced thereby. More particularly, in addition to first pores formed between lamellar layers of a resin, the invention introduces pore-forming particles during the manufacturing process, and, through a mechanism in which the lamellar layers of the resin are finely separated, forms second pores. As a result, the porous film manufactured by the method of the present invention has a reduced lamellar interlayer distance and improved porosity.

### TECHNICAL FIELD

The present invention relates to a method for manufacturing a porous film and a porous film manufactured thereby, and more particularly, to a novel method for manufacturing a porous film and a porous film manufactured thereby, in which pore-forming particles are added during the manufacturing process to finely separate the lamellar layers of the porous film resin, thereby forming pores, reducing the interlamellar spacing, and improving porosity.

### BACKGROUND ART

Rechargeable lithium-ion batteries (LIBs) were first commercialized in 1991. Because they offer high energy density, have no memory effect, and exhibit only a small degree of self-discharge when not in use, their applications have rapidly expanded to smartphones, portable power banks, wireless speakers, digital cameras, power tools, electric scooters, aircraft, automation equipment, and energy storage systems. In particular, as part of efforts to reduce global warming, electric vehicles are emerging as an alternative to policies aimed at phasing out internal combustion engines, and their market is growing explosively.

In a lithium-ion battery, the smallest component—the cell—is composed of four parts: a cathode, an anode, a separator, and an electrolyte. Among these components, the separator physically isolates the cathode from the anode to prevent direct contact, while its fine pores allow lithium ions to pass through during charging and discharging. In particular, the separator plays a key role in maintaining the safety of secondary batteries, making the stability of its quality critically important.

Commercialized separators generally must have very small pore sizes, a highly uniform pore size distribution, and high porosity in order to meet the required performance characteristics. In general, methods for producing porous films can be broadly classified into wet processes and dry processes, and the properties of the separator differ markedly depending on the manufacturing method. In the wet process, a thermoplastic resin composition is mixed with a filler or plasticizer, extruded into a film, and then the filler or plasticizer is extracted from the film to create pores. On the other hand, the dry process includes two main approaches: the stretching method, in which a thermoplastic resin is melt-extruded while controlling its crystalline structure, followed by pore formation through crazing and growth between lamellar crystals during stretching; and the interfacial delamination method, in which a filler is dispersed in a thermoplastic resin, melt-extruded to obtain a precursor film, and then stretched to delaminate the resin/filler interface, thereby forming pores.

In the separator manufacturing process, Korean Patent Publication No. 10-2017-0029399, filed by Samsung SDI, successfully attempted to introduce particles into the uniaxial stretching process, which is a dry separator manufacturing technology. In said patent, particles having a particle size smaller than the interlamellar spacing generated during the uniaxial stretching process were introduced, and extrusion conditions were specified so as to form an appropriate crystalline structure within the precursor. These limitations on the extrusion conditions served to restrict the formation of large stretching-induced pores that could otherwise occur during the particle-introduced stretching process. By defining such conditions, it was possible to maintain the pore-formation mechanism—interlamellar delamination—that occurs during uniaxial stretching, while forming fine pores. In other words, although particles were present inside the pores as in particle-stretching processes, the separator achieved small pore sizes with a uniform distribution, similar to uniaxially stretched separators, thereby enabling its use as a separator for secondary batteries.

However, when the separator employing the above-mentioned technology was applied to secondary batteries, it operated without significant issues at room temperature, but under the calendar-life evaluation condition of 60° C., it was found that the particles introduced for pore formation reduced the battery's lifespan, preventing commercialization. Furthermore, the particles introduced to form pores remained unbound-without chemical bonding to the separator matrix-inside the pores. As a result, in subsequent surface-coating processes, the inorganic particles added to the separator were not effectively anchored by the binder polymer to enhance heat resistance; instead, they simply remained as residues, increasing the overall weight of the assembled secondary battery. This, in turn, increased the weight of the vehicle's battery module and reduced the energy density per unit weight.

Accordingly, the present applicant has developed a new separator manufacturing process capable of overcoming the limitations of the conventional separators described above in their application to secondary batteries, thereby enabling commercialization.

### DISCLOSURE OF INVENTION

### Technical Problem

The present invention aims to provide a novel method for manufacturing a porous separator that solve the problems of the conventional separators and their manufacturing processes described above. In said method, particles for pore formation are introduced during the manufacturing process; the introduced particles induce interlamellar delamination during the stretching step; and, subsequently, the pore-forming particles are removed, thereby forming additional pores.

The present invention also aims to provide a porous separator having a novel structure, manufactured by the porous separator production method according to the present invention.

### Solution to Problem

The present invention provides a method for manufacturing a porous film to solve the above problems, comprising:
preparing a raw material mixture comprising a crystalline resin and pore-forming particles;
forming a film precursor from the raw material mixture;
uniaxially stretching the precursor to form a porous film containing the pore-forming particles; and
removing the pore-forming particles remaining in the formed porous film.

### <Crystalline Resin>

In the method for manufacturing a porous film according to the present invention, the crystalline resin may be, for example, polyethylene or polypropylene, and the type thereof is not particularly limited. It may be a homopolymer of propylene, a copolymer of propylene and another olefin and/or diolefin, or a mixture thereof, but a homopolymer is preferred. As olefins other than propylene, there may be used not only poly-3-methylbutene-1 and poly-4-methylpentene-1, but also propylene, 3-methylbutene-1,4-methylpentene-1, or copolymers of propylene with each other or with a small amount of other olefins, for example, copolymers of propylene and ethylene, a large amount of 3-methylbutene-1, and a small amount of linear n-alkenes such as n-octene-1, n-hexadecene-1, n-octadecene-1, or any of the same n-alkenes mentioned above in connection with 3-methylpentene-1 and 3-methylbutene-1, or combinations thereof.

Specifically, polypropylene, high-density polyethylene (HDPE), or copolymers thereof may be used, and their degree of crystallinity may be in the range of 20% to 95%, for example, 25% to 95%, or 30% to 95%. Specifically, a polypropylene resin having a crystallinity of 20% to 70% or a polyethylene resin having a crystallinity of 50% to 95% can be used. For polyethylene, the melt index (2.16 kg/190° C., ASTM D1238) may be 10 or less, specifically 5 or less, for example, 3 or less. For polypropylene, a resin having an isotacticity value of 85 to 100%, as measured by xylene solubility, may be used. In one example, polypropylene having a melting index (ASTM D1238) of 8 or less, more specifically 6 or less, may be used.

### <Pore-Forming Particles>

In the method for manufacturing a porous film according to the present invention, the pore-forming particles are characterized by comprising one or more selected from the group consisting of zinc oxide, magnesium hydroxide, aluminum hydroxide, basic magnesium carbonate, and calcium carbonate.

The pore-forming particles that can be used in the method for manufacturing a porous film according to the present invention may be inorganic particles, organic particles, or composite particles thereof, which have solubility in a chemical or solvent for particle removal so that they can be removed in a subsequent process. Examples of the inorganic particles include metal oxides, metal hydroxides, metal chlorides, metal carbonates, metal nitrates, and metal phosphates. Specific examples include zinc oxide, iron oxide, aluminum oxide, titanium oxide, silica, magnesium hydroxide, aluminum hydroxide, basic magnesium carbonate, and calcium carbonate. Examples of the organic particles include polymers of monomers containing double bonds produced by emulsion or suspension polymerization, and polymer precipitates formed in a solution by compatibility control. Specific examples include one or more organic particles selected from the group consisting of non-crosslinked polystyrene (PS), polymethyl methacrylate (PMMA), polyurethane (PU), polyvinyl alcohol (PVA), polyethylene oxide (PEO), polyamide (PA), silicone-acrylic rubber, acrylate copolymers, and cellulose derivatives. To facilitate easy removal of the particles in a subsequent process, an optimized dissolution process should be defined for each particle used, and a person skilled in the art can readily devise such a method.

In the method for manufacturing a porous film according to the present invention, the pore-forming particles are characterized by having a particle size of 3 nm to 300 nm, more specifically 5 nm to 250 nm, still more specifically 7 nm to 200 nm, and, for example, 10 nm to 100 nm.

In the method for manufacturing a porous film according to the present invention, when the size of the pore-forming particles becomes smaller than 3 nm, it is difficult to uniformly disperse them within the polymer, and, during stretching of the precursor film, the pore-forming particles act as stress concentration points. As a result, it becomes difficult to finely split the lamellar layers—which are structures of the microporous membrane produced in a dry-separation process and consist of 10 to 20 layers of lamellar crystals—making it hard to reduce the pore size. On the other hand, when the particle size exceeds 300 nm, there is no problem with dispersibility; however, the particle size becomes excessively larger than the thickness (about 0.2 μm) of the lamellar layer formed by the aggregation of 10 to 20 lamellar crystals, resulting in the drawback that a lamellar layer of the same size as in the conventional dry process is formed.

In the method for manufacturing a porous film according to the present invention, the size of the pore-forming particles may be from 0.1 to 20 times the thickness of the lamella formed from the crystalline resin, more specifically from 0.5 to 15 times, and most preferably from 1 to 10 times.

In the method for manufacturing a porous film according to the present invention, the pore-forming particles may be included in the precursor-forming composition in an amount of 3 to 30 parts by volume, specifically 3 to 28 parts by volume, and more specifically 5 to 25 parts by volume, based on the total volume of the composition.

When the pore-forming particles are included in the precursor-forming composition within the above range, a lamellar layer comprising fewer than 10 layers of lamellar crystals, which is induced by second pores generated by the pore-forming particles, is formed, and the uniformity of first pores, represented by a fibril structure, is improved. As a result, the spacing between lamellar layers in the porous film is reduced, and the porosity can be enhanced.

If the content of the pore-forming particles is less than 3 parts by volume, the amount of second pores generated by the pore-forming particles is insufficient, making it difficult to induce the formation of first pores while finely subdividing and separating the lamellar layers.

In the method for manufacturing a porous film according to the present invention, when the content of the pore-forming particles exceeds 30 parts by volume, the pore structure generated after extraction of the particles becomes excessively interconnected, thereby reducing the uniformity of the pores and increasing the likelihood of forming large through-pores. The precursor-forming composition may, as needed, appropriately include additives such as antioxidants, antistatic agents, neutralizers, dispersants, anti-blocking agents, and slip agents.

In the method for manufacturing a porous film according to the present invention, the raw material mixture may contain the pore-forming particles in a proportion of 3 to 30 parts by volume within the crystalline resin mixture.

Because the pore-forming particles used in the method for manufacturing a porous film according to the present invention have a very small particle size, from 3 nm to 300 nm or less, and are introduced in a very high content of 3 to 30 parts by volume, achieving uniform dispersion under general processing conditions is not easy. Therefore, compounding equipment and conditions capable of ensuring a high degree of dispersibility must be used, and, in addition, it is important to keep the resin temperature as low as possible in order to maintain a balance between thermodynamics and kinetics, thereby preventing re-agglomeration of the dispersed particles during processing.

Pelletizing of the raw material mixture can be readily carried out using equipment such as uniaxial extrusion following kneading at a rotational speed of less than 100 rpm, which allows sufficient mixing time. In the case of a twin-screw extruder, this is possible only when the residence time is maintained very long with a specific screw configuration. During the above compounding, the molten material may be used directly in the precursor film-forming process without forming pellets, or the pellets may be formed first and then used for precursor film formation.

### <Formation of the Precursor Film>

In the method for manufacturing a porous film according to the present invention, the thickness of the precursor film may range from 1 μm to 500 μm, for example, 1 μm to 300 μm, specifically 1 μm to 100 μm, more specifically 1 μm to 90 μm, and still more specifically 1 μm to 80 μm.

When the temperature and melting conditions for maintaining particle dispersion are appropriately set as described above, the process does not heavily depend on the equipment used. The method of extrusion molding for forming the precursor film is not particularly limited, and a single-screw or twin-screw extruder may be used to melt the crystalline resin and form the film using a T-die or annular die. Under these conditions, it is important that the molecular orientation in the precursor film is maximized, similar to the conditions required for the precursor film in the manufacture of a dry separation membrane.

In one example, two or more extruded precursor films may be laminated to produce a multilayer precursor film comprising two or more layers. In another example, a multilayer precursor film comprising two or more layers may be produced using co-extrusion. The multilayer precursor film can be formed either by supplying the molten precursor-forming compositions to separate manifolds of a multilayer die and stacking them in layers at the die lip inlet (multi-manifold method), or by arranging the molten precursor-forming compositions in a layered flow prior to supplying them to the die (block method). If co-extrusion is not used, the multilayer film can be formed by producing each precursor film separately and then laminating them together.

In the case of a multilayer precursor film comprising two or more layers, for example, it may have a two-layer structure of a lamella-forming crystalline resin/lamella-forming crystalline resin in which the content of the pore-forming particles differs, or a three-layer structure of a lamella-forming crystalline resin/lamella-forming crystalline resin/lamella-forming crystalline resin with differing pore-forming particle contents. In another example, when a precursor film containing pore-forming particles is used in one layer, the corresponding second or additional layers of lamella-forming crystalline resin may not contain any pore-forming particles.

### <Manufacturing of a Porous Film Containing Pore-Forming Particles>

In the method for manufacturing a porous film according to the present invention, the step of uniaxially stretching the precursor film to form a porous film containing pore-forming particles comprises:
annealing the precursor film at a temperature of (Tm−80° C.) to (Tm−3° C.);
first stretching of 5% to 140% at a temperature of 0° C. to 70° C. on the annealed film;
second stretching of 0% to 400% at a temperature of (Tm−90° C.) to (Tm−5° C.) on the stretched film; and
heat-setting the stretched film at a temperature of (Tm−90° C.) to (Tm−3° C.)

In the process for manufacturing a porous film according to the present invention, the annealing step is a high-temperature process that improves the crystalline and orientation structures through heat treatment, thereby promoting the formation of fine pores during stretching. In the manufacturing process, when the stretching ratio is properly adjusted to 50 or more, the annealing step may be shortened or even omitted.

Through the annealing step, the elastic recovery rate of the precursor film can be adjusted to 5% to 100%, specifically 10% to 100%, and more specifically 20% to 100%. When the elastic recovery rate is within this range, pore formation and pore size control in subsequent stretching steps are facilitated, and it becomes easier to achieve a morphology that includes both first pores and second pores. For example, annealing can be performed by placing the precursor film in roll form in a convection oven, contacting the precursor film with a heated roll or heated metal plate, or applying heat to the extruded precursor film using hot air or an IR heater in a tenter or similar device. The annealing temperature and time can be adjusted depending on the stretching ratio during the precursor film formation.

Subsequently, the annealed film may undergo a first stretching step of 5% to 140% at a low temperature, specifically 10% to 130%, and more specifically 20% to 120%. This low-temperature stretching step forms second pores between the particles and the polymer, which induces crazing throughout the entire area of the film and results in the formation of uniform first pores. For example, the film may be stretched in the machine direction (MD) while mounted on a fixed zig, or rolled using a stretching roll in the MD direction.

The low-temperature stretching temperature may vary depending on the lamella-forming crystalline material used, but for example, it may be in the range of 0 to 70° C. If the stretching ratio is less than 5%, deformation occurs within the elastic region of the precursor-forming composition, preventing uniform formation of the desired pores. When the stretching ratio is within the above range, small, uniform pores can be formed throughout the film, including its surface, and the tensile stress remains below the breaking strength, thereby avoiding premature rupture during the stretching process. The stretching ratio to maintain a low tensile stress may be 140% or less, more specifically 130% or less, and even more specifically 120% or less. Furthermore, when the stretching ratio is within the above range, sufficient cracks are formed during the low-temperature stretching process, enabling the achievement of the desired lamellar layer spacing and porosity.

The method for manufacturing a porous film according to the present invention includes a step of performing a second stretching of 0% to 400%, preferably 0% to 350%, and more preferably 0% to 300%, at a temperature of (Tm−90° C.) to (Tm−5° C.) on the first-stretched film. The second stretching allows for an increase in porosity and improves pore uniformity.

The second stretching may be adjusted depending on the type of precursor film. For example, in the case of polypropylene, it can be performed in the range of 76 to 161° C. Performing the first and second stretchings separately is particularly suitable as a method for maintaining surface pore uniformity while controlling the porosity.

In the method for manufacturing a porous film according to the present invention, when the second stretching ratio is 0%, the pores of the lamella-fibril structure formed during the first stretching are maintained, minimizing pore size and keeping the porosity at an appropriate level. When the second stretching ratio is less than 400%, the process facilitates enlargement of the slit pores, thereby increasing the porosity. However, when the second stretching ratio reaches 400% or more, there is a high risk of film rupture, making it unsuitable. To ensure a uniform pore structure and distribution, the second stretching may be performed, for example, by mounting the film on a fixed zig and stretching it in the longitudinal (machine, MD) direction at a temperature of (Tm−90)° C. to (Tm−5° C.), for example in an oven, or by using a roll-type device to stretch the film in the MD direction at the same temperature. The stretching ratio in the MD direction may be 0% to 400%, for example, 0% to 350%, or more specifically 0% to 300%.

The method for manufacturing the porous film according to the present invention may additionally include a heat-setting step if necessary. The heat-setting step comprises stretching the film in the longitudinal direction by 0% to 150% while applying heat, either while mounted on a fixed zig or using a roll-type device, and then relaxing the stretched precursor film to 80% to 100% of its total length.

Heat-setting is a process that reduces residual stress and shrinkage. Heat-setting can be performed at a temperature of (Tm−90° C.) to (Tm−3)° C. Even if heat-setting is not performed, the characteristics of the separation membrane are maintained; however, performing heat-setting additionally can produce a porous film with improved dimensional stability. For example, shrinkage at high temperatures is reduced, thereby enhancing dimensional stability in subsequent applications of the porous separation membrane.

### <Removal of Pore-Forming Particles>

In the method for manufacturing a porous film according to the present invention, after the pores of the porous film are formed, the pore-forming particles are removed. When the particles used as the pore-forming material are inorganic, they can be removed by immersion in an alkaline or acidic solution. When the particles are organic, they can be removed by dissolution or decomposition. The appropriate removal method is selected according to the type and characteristics of the particles.

If the particle removal step is performed immediately after the precursor formation step, it is difficult to extract the particles because the pores have not yet formed. If particle removal is performed after the low-temperature stretching step, pore formation is insufficient, resulting in a prolonged removal process and a limited removal rate. When the particle removal process is carried out after the high-temperature stretching or heat-setting step, the particles can be removed more easily. Therefore, it is preferable to perform the particle removal process after the high-temperature stretching step or the heat-setting step.

When using a liquid that affects the lamella-forming crystalline resin during the particle removal process, the pore structure may be affected. Therefore, compounds that do not affect the lamella-forming resin should be used whenever possible. When extracting particles using an acid or base, since the pores of the formed porous film are hydrophobic, it is appropriate to first wet the hydrophobic pores with a suitable solvent before treating with acid or base, or to mix the acid or base with a suitable solvent to impart compatibility before extraction. Examples of such solvents include, but are not limited to, one or more selected from the group consisting of saturated hydrocarbons such as pentane, hexane, or heptane; chlorinated hydrocarbons such as methylene chloride or carbon tetrachloride; alcohols such as methanol or ethanol; ethers such as diethyl ether or dioxane; esters such as methyl acetate or ethyl acetate; ketones such as methyl ethyl ketone; and fluorinated organic compounds.

In the method for manufacturing a porous film according to the present invention, it is preferable to remove as much of the introduced particles as possible during the particle removal process; however, due to process limitations, a small amount of pore-forming particles may remain. The residual pore-forming particles are preferably maintained at 5% or less of the introduced particles, more preferably 3% or less, even more preferably 1% or less, and most preferably 0.5% or less.

The removal rate during the particle extraction process can vary significantly depending on the composition of the particles. Preferably, inorganic particles are used, and more preferably, particles in the form of metal oxides, metal hydroxides, or metal carbonates are advantageous for the process. After completion of the particle removal process, washing can be performed by immersing the film in a washing solvent, by showering the washing solvent over the film, or by a combination of these methods. It is preferable to use 300 to 30,000 parts by weight of the washing solvent per 100 parts by weight of the membrane. The washing temperature is generally 15-30° C., but heated washing may be applied if necessary. The washing solvent should be removed until the residual amount of liquid solvent is less than 1% by weight of the originally added amount.

In the method for manufacturing a porous film according to the present invention, after washing, the particle-removed fine porous membrane is dried using a heated drying method or an air-drying method. The washing and drying temperature is preferably 80° C. or below.

The present invention also provides a porous film manufactured by the method of the present invention.

The porous film according to the present invention comprises first pores formed between lamella layers of a crystalline resin; and second pores formed by particles introduced for pore formation, wherein the volume of the second pores is larger than the volume of the first pores.

In one embodiment of the present invention, the porosity of the porous film may be 45 to 70%, preferably 55 to 70%.

The porous film according to the present invention is characterized in that the lamella layers are stacked in seven layers or fewer. In the porous film of the present invention, the lamellae are formed as a layered structure with single-crystal lamella layers of seven layers or fewer due to the lamella-opening mechanism caused by the pore-forming particles. In contrast, porous films prepared by conventional dry methods may have a layered structure with at least ten single-crystal lamella layers stacked.

The porous film according to the present invention is characterized in that the crystallinity is 20% to 95%.

The porous film according to the present invention comprises 1 wt % or less of the pore-forming particles. While it is preferable to remove as much of the introduced particles as possible during the particle removal process, a small amount of pore-forming particles may remain due to process limitations. The residual pore-forming particles are preferably maintained at 5% or less of the introduced particles, more preferably 3% or less, even more preferably 1% or less, and most preferably 0.5% or less.

The present invention also provides a porous film having a porous coating containing inorganic materials on one or both sides of the porous film according to the present invention.

The present invention further provides an electrochemical device comprising the porous film according to the present invention.

### Advantageous Effects of Invention

The method for manufacturing a porous film according to the present invention involves preparing a precursor by incorporating pore-forming particles into a crystalline resin, and then forming a porous film by annealing, stretching, and heat-setting the precursor, followed by removing the pore-forming particles. In this process, the pore-forming particles finely subdivide the lamella layers during the formation of the porous film, and the subsequent removal of the pore-forming particles generates additional pores, thereby reducing the spacing between lamella layers and increasing the porosity of the porous film.

### BRIEF DESCRIPTION OF DRAWINGS

FIG. 1 shows the results of a lifetime evaluation at a storage temperature of 60° C. for batteries containing porous films prepared in Example 1 and Comparative Example 1 of the present invention.

### MODE FOR CARRYING OUT THE INVENTION

Hereinafter, the present invention will be described in more detail with reference to examples. However, the present invention is not limited to the following examples.

### Example 1

### [Example 1-1] Preparation of Precursor Film

For 85 vol % of polypropylene (PP S801 [Daehan Petrochemical Co., MI 3.0, isotacticity 98%, Tm: 166° C.]), 15 vol % of hydrophobic CaCO₃ (BK07, Dongho Calcium Co.), surface-modified by reaction with sodium stearate and having an average particle size of 40 nm, was mixed as pore-forming particles.

Using a pressurized kneader extruder with a capacity of 100 L, the barrel temperature was set to 150° C., and the prepared raw materials were kneaded at a rotation speed of 30 rpm until the final resin temperature reached 200° C. After kneading with the kneader, pelletization was carried out by the strand-cutting method using a single-screw extruder equipped with a conical screw feeder.

The precursor film was produced by a blown-film method: the pellets were melt-extruded with a single-screw extruder at a resin temperature of 200° C. through an annular die (2.5 mm opening, 100 mm diameter). The extruder temperatures were 165/175/185/195° C., and the die temperature was 195° C. The extruder had a diameter of 70 mm and an L/D ratio of 24:1, operated at 25 rpm.

The air bubble BUR was maintained at 1.4, and the draw-down ratio at 51, resulting in a film 200 mm wide and 30-35 μm thick.

### [Example 1-2] Formation of Film Containing Pore-Forming Particles by Annealing, Stretching, and Heat-Setting

The precursor film was annealed at 130° C. for 30 minutes, followed by cold stretching at 25° C. with 60% elongation and hot stretching at 120° C. with 220% elongation. Annealing and hot stretching were performed by placing the film in a zig setup inside a high-temperature oven. After hot stretching, heat-setting was carried out at 140° C. for 30 minutes. The final thickness of the obtained film was 16.5 μm.

### [Example 1-3] Removal of Pore-Forming Particles

To remove the pore-forming particles remaining in the film, the film was immersed at 25° C. in an acidic solution prepared by mixing 35% hydrochloric acid and 95% ethanol so that the concentration of hydrochloric acid was 5 wt %.

The pore-forming particles dissolved in the acidic solution while generating CO₂. The film, from which the hydrochloric acid had been removed, was subsequently immersed three times in 95% ethanol to eliminate residual hydrochloric acid and then dried at room temperature.

### Example 2

### [Example 2-1] Preparation of Precursor Film

For 85 parts by volume of high-density polyethylene (Prime Polymer, MI 0.3, density 0.96 g/cm³, Tm 136° C.), 15 parts by volume of BK07 (Dongho Calcium Co.), a hydrophobic CaCO₃ surface-modified by reaction with sodium stearate and having an average particle size of 40 nm, was mixed as a pore-forming particles.

Using a 100 L pressurized kneader extruder, the barrel temperature was set to 150° C., and the prepared materials were kneaded at a rotation speed of 30 rpm until the final resin temperature reached 200° C. After kneading in the kneader, the mixture was pelletized by the strand-cutting method using a single-screw extruder equipped with a conical screw feeder.

The precursor film was produced by a blown-film method: the pellets were melt-extruded with a single-screw extruder at a resin temperature of 200° C. through an annular die (2.5 mm opening, 100 mm diameter). The extruder temperatures were 165/175/185/195° C., and the die temperature was 195° C. The extruder had a diameter of 70 mm and an L/D ratio of 24:1, operated at 25 rpm. The air bubble BUR was maintained at 1.4, and the draw-down ratio at 51, resulting in a film 200 mm wide and 30-35 μm thick.

### [Example 2-2] Formation of Film Containing Pore-Forming Particles by Annealing, Stretching, and Heat-Setting

The precursor film was annealed at 120° C. for 30 minutes, followed by cold stretching at 25° C. with 100% elongation and hot stretching at 120° C. with 100% elongation. Annealing and hot stretching were performed by placing the film in a zig setup inside a high-temperature oven. After hot stretching, heat-setting was carried out at 130° C. for 30 minutes. The final thickness of the obtained film was 17 μm.

### [Example 2-3] Removal of Pore-Forming Particles

To remove the pore-forming particles remaining in the film, the film was immersed at 25° C. in an acidic solution prepared by mixing 35% hydrochloric acid and 95% ethanol so that the concentration of hydrochloric acid was 5 wt %.

The pore-forming particles dissolved in the acidic solution while generating CO₂. The film, from which the hydrochloric acid had been removed, was subsequently immersed three times in 95% ethanol to eliminate residual hydrochloric acid and then dried at room temperature.

### Comparative Example 1

A film was obtained by carrying out the same procedure as in Example 1 under the conditions shown in Table 1, except that the step of removing the particles was not performed.

### Comparative Example 2

A film was obtained by carrying out the same procedure as in Example 2 under the conditions shown in Table 1, except that the step of removing the particles was not performed.

### Experimental Example 1: Measurement of Air Permeability of Porous Films

To measure the air permeability of the porous films of the above Examples and Comparative Examples, each porous film was mounted on a zig having a diameter of 14.5 cm and an area of 165 cm². A pressure of 0.03 MPa was applied to one side of the separator for 40 seconds, and the air that permeated through to the opposite side was collected under water. Its volume was measured in milliliters, and the results are shown in Table 1.

The differential pressure between the separator surfaces was measured using a manometer installed across the separator, and the pressure unit was expressed in mmH₂O. The measured air volume was divided by the measured pressure to obtain the air permeability. The final unit was expressed as ml/mmH₂O (40 sec) (165 cm²).

### Experimental Example 2: Measurement of Porosity of Porous Films

To measure the porosity of the films of the above Examples and Comparative Examples, each porous film was wetted with a liquid that easily wets the porous film and evaporates slowly. After removing any liquid remaining on the surface of the film that had become transparent upon wetting, the weight was compared with the weight before wetting, and the porosity was calculated. The results are shown in Table 1. The liquid used was Tween-80, with a density of 1.078 g/ml.

### Experimental Example 3: Evaluation of Electrochemical Properties

### [Experimental Example 3-1] Preparation of Battery

For the preparation of the cathode, the active material was LiCoO₂ (KD-10, Umicore) powder at 92 wt %, the conductive agent was carbon black (Super P, TIMCAL) at 4 wt %, and the binder was PVdF (SOLEF 6020, Solvay SA) at 4 wt %. These components were mixed with the solvent NMP and uniformly coated onto an aluminum foil, followed by vacuum drying at 100° C. and compression using a double roll press to increase the packing density, producing the cathode plate. For the anode, the active material was Artificial graphite (SCMG-AR, SHOWA DENKO) at 93 wt %, the conductive agent was carbon black (Super P, TIMCAL) at 2 wt %, and the binder was PVdF (SOLEF 6020, Solvay SA) at 5 wt %. These components were mixed with the solvent NMP, uniformly coated onto a copper foil, and vacuum-dried at 60° C. The anode plate was then compressed in the same manner as the cathode to increase the packing density. The electrolyte used was an EC/DEC (1:1 v/v) solution containing 1 M LiPF₆, supplied by Panax Etec Co., Ltd.

### [Experimental Example 3-2] Lifetime Evaluation at a Storage Temperature of 60° C.

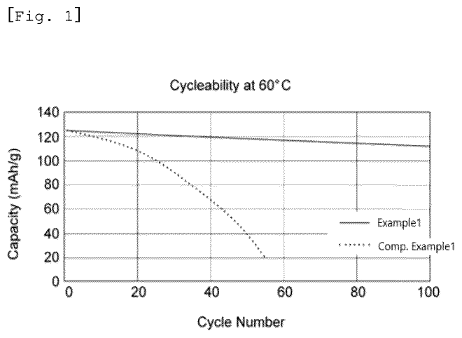

For electrochemical evaluation, coin-type full cells were assembled using the separators from Example 1 and Comparative Example 1 under an argon atmosphere. Charge-discharge tests were then carried out using a PEBC050.1 charge-discharge tester (PNE Solution Co.), and the results are shown in FIG. 1 and Table 1.

Considering electrochemical stability, charge-discharge was performed within a voltage range of 3.0-4.2 V. The precycle was carried out at a current rate of 0.1 C, and the cycling performance was evaluated up to 100 cycles at 0.5 C.

The capacity retention was calculated by dividing the remaining capacity after 100 cycles by the initial capacity. Samples that did not complete evaluation up to 100 cycles were marked as Failure.

TABLE 1

| | | | | | Comp. | | Comp. | |
|---|---|---|---|---|---|---|---|---|
| | Example 1 | | Example 2 | | Example 1 | | Example 2 | |
| polymer type | PP | | PE | | PP | | PE | |
| particle type | CaCO₃ | | CaCO₃ | | CaCO₃ | | CaCO₃ | |
| particle size | 40 | nm | 40 | nm | 40 | nm | 40 | nm |
| particle | 15 | | 15 | | 15 | | 15 | |
| content(Vol %) | | | | | | | | |
| PP content(Vol %) | 85 | | 85 | | 85 | | 85 | |
| resin kneading | 200° | C. | 200° | C. | 200° | C. | 200° | C. |
| temperature | | | | | | | | |
| rpm during | 30 | | 30 | | 30 | | 30 | |
| kneading | | | | | | | | |
| resin temperature | 200° | C. | 200° | C. | 200° | C. | 200° | C. |
| during film | | | | | | | | |
| formation | | | | | | | | |
| rpm during film | 25 | | 25 | | 25 | | 25 | |
| formation | | | | | | | | |
| Draw Ratio | 51 | | 51 | | 51 | | 51 | |
| crystallization | 130° | C. | 120° | C. | 130° | C. | 120° | C. |
| temperature | | | | | | | | |
| precusor thickness | 35 | μm | 35 | μm | 35 | μm | 35 | μm |
| room-temperature | 60% | | 100% | | 60% | | 100% | |
| stretching(25° C.) | | | | | | | | |
| high-temperature | 220% | | 100% | | 220% | | 100% | |
| draw ratio(120° C.) | | | | | | | | |
| Heat Setting Temp | 140° | C. | 130° | C. | 140° | C. | 130° | C. |
| Heat Setting Time | 30 | min | 30 | min | 30 | min | 30 | min |

| particle removal | ◯ | ◯ | X | X |
|---|---|---|---|---|
| status | | | | |
| porous film | 16.5 | 17 | 18 | 18 |
| thickness (μm) | | | | |
| air permeability | 3.7 | 3.1 | 3.1 | 2.5 |
| porosity | 60 | 61 | 50 | 52 |
| high-temperature | 90.0% | 87% | Failure | Failure |
| battery capacity | | | | |
| retention | | | | |
| (60° C., 100Cy) | | | | |

As shown in Table 1, in the cases of Example 1 and Example 2 according to the present invention, the air permeability and porosity were improved, and the lifetime property was enhanced compared to Comparative Example 1 and Comparative Example 2.

1. A method for manufacturing a porous film, comprising:
preparing a raw material mixture comprising a crystalline resin and pore-forming particles;
forming a precursor film by extrusion-molding the raw material mixture;
uniaxially stretching the precursor film to form a porous film containing the pore-forming particles; and
removing the pore-forming particles remaining in the formed porous film.

2. The method of claim 1,
wherein the pore-forming particles are one or more selected from the group consisting of zinc oxide, magnesium hydroxide, aluminum hydroxide, basic magnesium carbonate, and calcium carbonate.

3. The method of claim 1,
wherein the pore-forming particles have a particle size of 3 nm to 300 nm.

4. The method of claim 1,
wherein the pore-forming particles are comprised in the precursor-forming composition in an amount of 3 to 30 parts by volume.

5. The method of claim 1,
wherein the uniaxially stretching the precursor film to form a porous film containing pore-forming particles comprises:
annealing the precursor film at a temperature of (Tm−80° C.) to (Tm−3° C.);
first stretching of 5% to 140% at a temperature of 0° C. to 70° C. on the annealed film;
second stretching of 0% to 400% at a temperature of (Tm−90° C.) to (Tm−5° C.) on the stretched film; and
heat-setting the stretched film at a temperature of (Tm−90)° C. to (Tm−3)° C.

6. A porous film produced by the method according to claim 1, comprising:
first pores formed between lamella layers of a crystalline resin; and
second pores formed by particles introduced for pore formation,
wherein the volume of the second pores is larger than the volume of the first pores.

7. The porous film of claim 6,
wherein a porosity of the porous film is 45 to 70%.

8. The porous film of claim 6,
wherein the lamella layers are stacked in seven layers or fewer.

9. The porous film of claim 6,
wherein crystallinity of the porous film is 20% to 95%.

10. The porous film of claim 6,
wherein the porous film comprises 1 wt % or less of the pore-forming particles.

11. An electrochemical device comprising the porous film of claim 6.
